(19) United States
(12) Patent Application Publication
(10) Pub. No.: US 2010/0329340 A1
(43) Pub. Date: Dec. 30, 2010

(54) METHOD AND APPARATUS FOR ELIMINATING ENCODING DELAY WHEN A TELECINE SOURCE MATERIAL IS DETECTED

(75) Inventors: Robert S. Nemiroff, Carlsbad, CA (US); Jing Yang Chen, San Diego, CA (US)

Correspondence Address: Motorola, Inc., 600 North US Highway 45, W4 - 39Q, Libertyville, IL, 60048-5343, US

(73) Assignee: GENERAL INSTRUMENT CORPORATION, Horsham, PA (US)

(21) Appl. No.: 12/491,455

(22) Filed: Jun. 25, 2009

(51) Int. Cl. H04N 7/32; H04N 7/26

(52) U.S. Cl. 375/240.16; 375/240.01; 375/E07.125

(57) ABSTRACT

A video encoder includes an inverse telecine detector for receiving video frames and generating a telecine detection signal identifying repeated frames and an encoder pipeline buffer for storing unrepeated video frames received from the inverse telecine detector. The video encoder also includes an encoder engine for encoding the unrepeated video frames received from the encoder pipeline buffer, a pre-encoded frame storage medium for storing pre-encoded frames, and a processor. The processor is configured to cause the encoder engine to replace selected frames that have been identified as repeating frames by the inverse telecine detector with a pre-encoded frame accessed from the pre-encoded frame storage medium.

### FIELD OF THE INVENTION

The present invention relates generally to video encoding, and more particularly to a method and apparatus for encoding video in which a telecine pattern is detected.

### BACKGROUND

Motion picture photography or film has a rate of 24 frames per second. Every frame itself is a complete picture, also known as a “progressive frame.” This means that all fields, top and bottom, correspond to the same instant of time.

Video signals, on the other hand, may have a progressive frame structure or an interlaced structure. An interlaced frame is divided into top and bottom fields, and scanning of one field does not start until the other one is finished. Moreover, video has a different frame rate than film. The NTSC standard (used primarily in North America) uses a frame rate of approximately thirty frames per second for interlaced video. The PAL standard (used in most of the rest of the world) uses a frame rate of twenty-five frames per second. Progressive video uses a frame rate of 60 frames per second.

The different frame rates used by film and video complicate the conversion between the two formats. In order to solve the problem of having extra video frames when converting film to be shown on television, a telecine process converts multiple frames of film into five frames of video. For progressive video at a frame rate of 60 frames per second, two frames of film are converted into five frames of video. One method of performing this process involves converting a first frame of film into three frames of video and a second frame of film into two frames video. That is, the first frame of film is repeated twice and the second frame of film of repeated once. Because of the 3-2 pattern, the process is often called 3-2 pulldown. This pattern is illustrated generally in FIG. 1, where two film frames A and B are converted into 5 frames. In this example film frame A is repeated once to produce video frames A1 and A2 and film frame B is repeated twice to produce video frames B1, B2 and B3.

The repeated or duplicate frames in the telecine process enable the viewing of film materials in the video format. However, in some applications, it is desirable to remove the duplicate frames. For example, the repeated frames do not contain new information and should be removed before encoding (compression). An inverse telecine process, also referred to as a detelecine process, converts a video signal back to a film format. This process takes incoming video, which is presumed to have been generated from film source material, and outputs the original frame images so that they can be encoded. By removing repeated frames from the video material, the encoding process can be made more efficient, and ultimately the amount of the resulting data can be greatly reduced.

Video encoders typically compress the video because video can require an enormous amount of digital storage if left uncompressed. One method for compressing digital video involves using the standards of the Moving Pictures Experts Group (MPEG). The MPEG-2 standard calls for three types of frames to be encoded. Intra-frames, or I-frames are encoded in the same manner as still images; an I-frame contains information sufficient to display an entire image. Predictive frames, or P-frames use previous reference frames to determine what the current frame will be by recording changes between a previous frame and the current frame. Bi-directional frames, or B-frames use previous and subsequent reference frames to determine what the current frame will be. P-frames and B-frames use motion vectors to encode frames. A motion vector determines movement between specific areas of one frame to another frame. For example, a P-frame may be encoded by referencing an I-frame immediately preceding it. Motion vectors between the P-frame and the I-frame instruct a decoder to display the P-frame by movement of certain areas within the I-frame which results in the proper display of the P-frame.

One method of encoding digital video calls for grouping frames together into what are known as Groups of Pictures (GOPs). A GOP may begin with an I-frame, and have P-frames and B-frames which refer to the I frame. A P-frame or a B-frame can refer to either an I-frame or a P-frame, but not to a B-frame. The length and order of GOPs can be determined before encoding or dynamically, while the encoder is encoding. An example of a sequence of a GOP may be IBBPBBPBB in display order, meaning an I-frame, followed by two B frames, a P frame, two more B-frames, another P-frame, and two more B-frames. In an encoder which determines the order of a GOP prior to encoding, this sequence would repeat itself. In the above sequence, the first P-frame will refer back to the first I-frame, since it cannot refer to a B-frame, and must refer to a frame that occurs before it. The B-frames may refer to the I- or P-frame just preceding it in display order and/or the I- or P-frame just following it in display order.

A block diagram of one example of a digital video encoder that may be used to encode video that has been converted from film source material is shown in FIG. 2. Video is input to an inverse telecine detector 60, which detects and drops any repeat frames. The inverse telecine detector 60 also inserts a flag into the video stream to indicate to the downlink decoder that certain frames should be repeated at the appropriate time. The remaining video frames are then stored in an encoder pipeline buffer 65 before they are sequentially delivered to the input of a video encoder engine 70, which performs the actual encoding. The buffer 65 and encoder engine 70 operate under the control of a processor 75, which establishes the video pipeline that delivers the frames from the buffer 65 to the encoder engine 70.

Video encoders such as shown in FIG. 2 have a pipeline delay from the time a frame is input to the pipeline buffer 65 to the time that the frame is encoded by the encoding engine 70. The pipeline is typically equal to about 1 GOP or more so that the encoder can analyze the complexity of an entire GOP prior to encoding. The duration of a GOP is typically one second. When a repeated frame is removed or dropped during the encoding process, that frame is not sent to the pipeline. There are two ways the encoder can manage the pipeline when a frame is dropped, which will be described with reference to FIG. 3.

FIG. 3 shows three different ways in which the pipeline can be filled. In the first case, shown at the top of the figure, 10 frames are sent to the video pipeline. None of the frames are repeated and thus none of the frames are dropped. Each frame enters the pipeline in sequence. The pipeline has a duration equal to the sum of the durations of the individual frames in the pipeline. The duration of each individual frame is referred to herein as the frame time. In the second case shown in FIG. 3 repeated frames are included in the pipeline and these frames are dropped or skipped by an inverse telecine detection process prior to entering the pipeline. For purposes of illustration only 1 out of 3 frames are dropped in this example. As shown in FIG. 3, a placeholder or “bubble” is created for each dropped or skipped frame. The bubble proceeds to move through the pipeline as if the frame were present. However, when an encoding process is to be performed on that dropped frame, the process is simply not performed. In this way each of the remaining frames continue to incrementally move along the pipeline as if no frames have been dropped. Accordingly, as shown in FIG. 3, after 10 frame times have passed, the first frame will begin to be encoded.

The third case shown in FIG. 3 illustrates an alternative way in which the pipeline may be filled when frames are dropped. In this case when a frame is dropped the entire pipeline stops. For instance, when a frame to be dropped enters the pipeline at frame time 3, the pipeline stops so that frames 1 and 2 do not incrementally move forward along the pipeline. That is, the pipeline stalls between frame times 2 and 3. Likewise, the pipeline in this example stalls between frame times 5 and 6, 8 and 9 and 11 and 12. As a result, the first frame does not begin to be encoded until frame time 14, whereas in the second case shown in FIG. 3 the first frame began to be encoded at frame time 10. Thus, by stopping the pipeline instead of using a placeholder or bubble when a frame is dropped, the pipeline in this example is delayed by 4 frame times.

In the case of 3-2 pulldown, for every five frames of film that are to be encoded three are dropped (i.e., only two frames are encoded). If the pipeline has a duration of one second, by the time the last frame in the pipeline begins to be encoded the pipeline will have been delayed by ⅗ of a second, or 600 ms. This delay significantly reduces the time that is available between the time a frame is encoded and the time it is to be decoded by the decoder, which is specified by the frame's decode time stamp. As a result of this delay, the frame must be compressed more aggressively to prevent underflow in the decoder buffer. Consequently, video quality will be degraded due to the aggressive compression.

### SUMMARY

In accordance with one aspect of the invention, a video encoder is provided which includes an inverse telecine detector for receiving video frames and generating a telecine detection signal identifying repeated frames and an encoder pipeline buffer for storing unrepeated video frames received from the inverse telecine detector. The video encoder also includes an encoder engine for encoding the unrepeated video frames received from the encoder pipeline buffer, a pre-encoded frame storage medium for storing pre-encoded frames, and a processor. The processor is configured to cause the encoder engine to replace selected frames that have been identified as repeating frames by the inverse telecine detector with a pre-encoded frame accessed from the pre-encoded frame storage medium.

In accordance with another aspect of the invention, a method is provided for encoding a series of video frames. In accordance with the method, a series of video frames are received and a pattern is detected in the series indicative of a telecine process. Repeated video frames are removed from the series of video frames and replaced with pre-encoded video frames selected from a plurality of pre-encoded video frames. Each of the video frames in the series of frames that have not been pre-encoded are sequentially encoded.

### BRIEF DESCRIPTION OF THE DRAWINGS

FIG. 1 illustrates a forward telecine or 3-2 pulldown process for a sequence of frames.

FIG. 2 shows a simplified block diagram of one example of a digital video encoder that may be used to encode video that has been converted from film source material.

FIG. 3 shows three different ways in which a video encoder pipeline can be filled.

FIG. 4 shows one example of a content delivery system that employs digital video encoders at various locations.

FIG. 5 shows a simplified block diagram of one example of a digital video encoder which employs a pipeline in which repeated frames are replaced with a pre-encoded frame instead of being dropped.

FIG. 6 shows one example of an encoder engine that may be employed in the digital video encoder of FIG. 5.

FIG. 7 shows a sequence of P and B frames within an individual GOP which are used to illustrate the process in which a repeated frame is replaced with a frame that has been pre-encoded and stored in memory.

### DETAILED DESCRIPTION

The present invention relates to devices and methods for efficiently encoding digital video. This invention may be used to increase efficiency when encoding video that has been processed using a 3:2 pull down process. Although the embodiments described below relate to encoding video that has been processed using a 3:2 pull down process, it is understood that the present invention may be used for any type of video that has been converted from film source material, including both interlaced and progressive video formats.

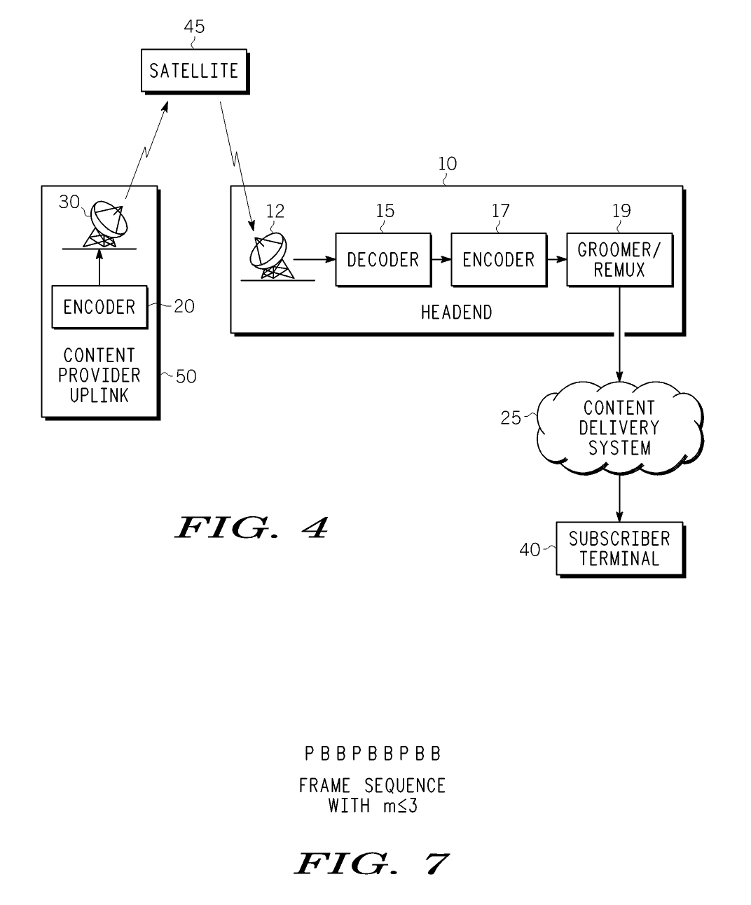

The methods and techniques discussed herein are applicable to digital video encoders that may be employed in a wide variety of different environments and thus is not limited to an encoder that is configured for any one particular application. In some cases, however, these methods and techniques may be particularly suitable for use in one or more of the various encoders that are employed in a content delivery system that is used to deliver programming content to subscribers, an example of which will be presented in connection with FIG. 4.

FIG. 4 shows one example of a full service content delivery system. A content provider uplink 50 delivers digital programming content to a geostationary orbiting satellite 45. The satellite 45 receives the uplinked content and rebroadcasts them to a downlink antenna located in a headend 10. The content provider uplink 50 includes an encoder 20 and a satellite transmitter 30. The encoder digitally encodes the content and the satellite transmitter 30 transmits the encoded content in the form of RF signals, which may be, for example, in a Quadrature Phase Shift Key (QPSK) modulated format. The headend 10 includes a satellite receiving dish or antenna 12 followed by a decoder 15, another encoder 17 and a groomer/remultiplexer 19 that may combine the encoded content with other content available to the headend prior to delivery to subscriber terminals 40

The headend 10 delivers the programming content received from the content provider to subscriber terminals 40 over a content delivery system 25. Illustrative examples of the content delivery system 25 include, but are not limited to, broadcast television networks, cable data networks, xDSL (e.g., ADSL, ADLS2, ADSL2+, VDSL, and VDSL2) systems, satellite television networks and packet-switched networks such as Ethernet networks, and Internet networks. In the case of a cable data network, an all-coaxial or a hybrid-fiber/coax (HFC) network may be employed. The all-coaxial or HFC network generally includes an edge QAM modulator and a hybrid fiber-coax (HFC) network, for example. The edge modulator receives Ethernet frames that encapsulate transport packets, de-capsulate these frames and removes network jitter, implements modulation and, performs frequency up-conversion and transmits radio frequency signals representative of the transport stream packets to end users over the HFC network. In the HFC network, the transport stream is distributed from the headend 10 (e.g., a central office) to a number of second level facilities (distribution hubs). Each hub in turn distributes carriers to a number of fiber nodes. In a typical arrangement, the distribution medium from the head-end down to the fiber node level is optical fibers. Subscriber homes are connected to fiber hubs via coaxial cables. In the case of a packet-switched network, any suitable network-level protocol may be employed. While the IP protocol suite is often used, other standard and/or proprietary communication protocols are suitable substitutes.

Subscriber terminals 40 may be any device that can receive, decode and, if necessary, decrypt the content received over the content delivery system 25. Illustrative examples of subscriber terminals include set top boxes, personal computers, media centers, and the like.

A simplified block diagram of one example of a digital video encoder such as encoder 20 or encoder 17 which operates in accordance with the methods and techniques described herein is shown in FIG. 5. The video encoder includes inverse telecine detector 160, which detects and tags or otherwise identifies any repeat frames, encoder pipeline buffer 165 for storing the video frames prior to encoding, video encoder engine 170, and pre-encoded frame storage medium 180, the function and operation of which will be explained below. The inverse telecine detector 160, encoder pipeline buffer 165, video encoder engine 170 and pre-encoded frame storage medium 180 operate under the control of a processor 175.

It will be understood that the function of the various components of the video encoder shown in FIG. 5 may be carried out using hardware, software, firmware, or any combination thereof. That is, the particular functional elements set forth in FIG. 5 are shown for purposes of clarity only and do not necessarily correspond to discrete physical elements.

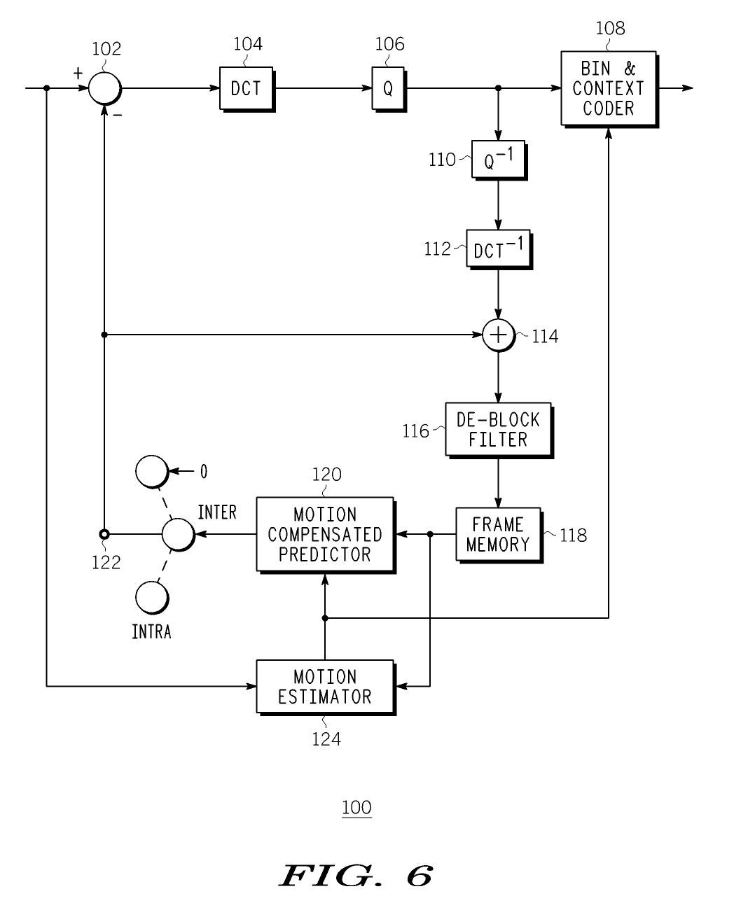

One example of an encoder engine is shown in FIG. 6. In some embodiments, the video encoder is compliant with the MPEG-2 or H.264 standard. The video encoder 100 may include a subtractor 102, a discrete cosine transform (DCT) module 104, a quantizer 106, a bin and context coder (e.g. entropy coder) 108, an inverse quantizer 110, an inverse DCT module 112, a summer 114, a deblocking filter 116, a frame memory 118, a motion compensated predictor 120, an intra/inter switch 122, and a motion estimator 124. In operation, the video encoder 100 receives an input sequence of source frames from the video pipeline. The subtractor 102 receives a source frame from the input sequence and a predicted frame from the intra/inter switch 122. The subtractor 102 computes a difference between the source frame and the predicted frame, which is provided to the DCT module 104. In INTER mode, the predicted frame is generated by the motion compensated predictor 120. In INTRA mode, the predicted frame is zero and thus the output of the subtractor 102 is the source frame.

The DCT module 104 transforms the difference signal from the pixel domain to the frequency domain using a DCT algorithm to produce a set of coefficients. The quantizer 106 quantizes the DCT coefficients. The entropy coder 108 codes the quantized DCT coefficients to produce a coded frame. The inverse quantizer 110 performs the inverse operation of the quantizer 106 to recover the DCT coefficients. The inverse DCT module 112 performs the inverse operation of the DCT module 104 to produce an estimated signal. If no prediction was used, the output of the DCT is the estimated frame. If prediction was used, the output of the inverse DCT is the estimated difference signal. The estimated difference signal is added to the predicted frame by the summer 114 to produce an estimated frame, which is coupled to the deblocking filter 116. The deblocking filter deblocks the estimated frame and stores the estimated frame or reference frame in the frame memory 118. The motion compensated predictor 120 and the motion estimator 124 are coupled to the frame memory 118 and are configured to obtain one or more previously estimated frames (previously coded frames).

The motion estimator 124 also receives the source frame. The motion estimator 124 performs a motion estimation algorithm using the source frame and a previous estimated frame (i.e., reference frame) to produce motion estimation data. The motion estimation data is provided to the entropy coder 108 and the motion compensated predictor 120. The entropy coder 108 codes the motion estimation data to produce coded motion data. The motion compensated predictor 120 performs a motion compensation algorithm using a previous estimated frame and the motion estimation data to produce the predicted frame, which is coupled to the intra/inter switch 122. Motion estimation and motion compensation algorithms are well known in the art.

As previously mentioned, the pipeline to the video encoder may undergo significant delays if it is stopped each time a repeated frame is dropped when encoding video that has been converted from film. To overcome this problem, instead of dropping the repeated frame, the frame is tagged by the inverse telecine detector to identify it as a repeated frame. Then, instead of using the encoding engine to encode the repeated frame, the repeated frame is replaced with a frame that has been pre-encoded and stored in a memory such as the pre-encoded frame storage 180. In the example shown in FIG. 5, inverse telecine detector 160, flags the repeated frames to processor 175. The processor 175, in turn, instructs the video encoder engine 170 when to insert the pre-encoded frames from the pre-encoded frame storage 180 in order to replace the repeated frames. This process will be further explained in connection with FIG. 7, which shows a sequence of P and B frames within an individual GOP. In this example, the number of frames from one anchor frame to another anchor frame is assumed to be 3 (i.e., m=3). However, the process is equally applicable to other values of m as well.

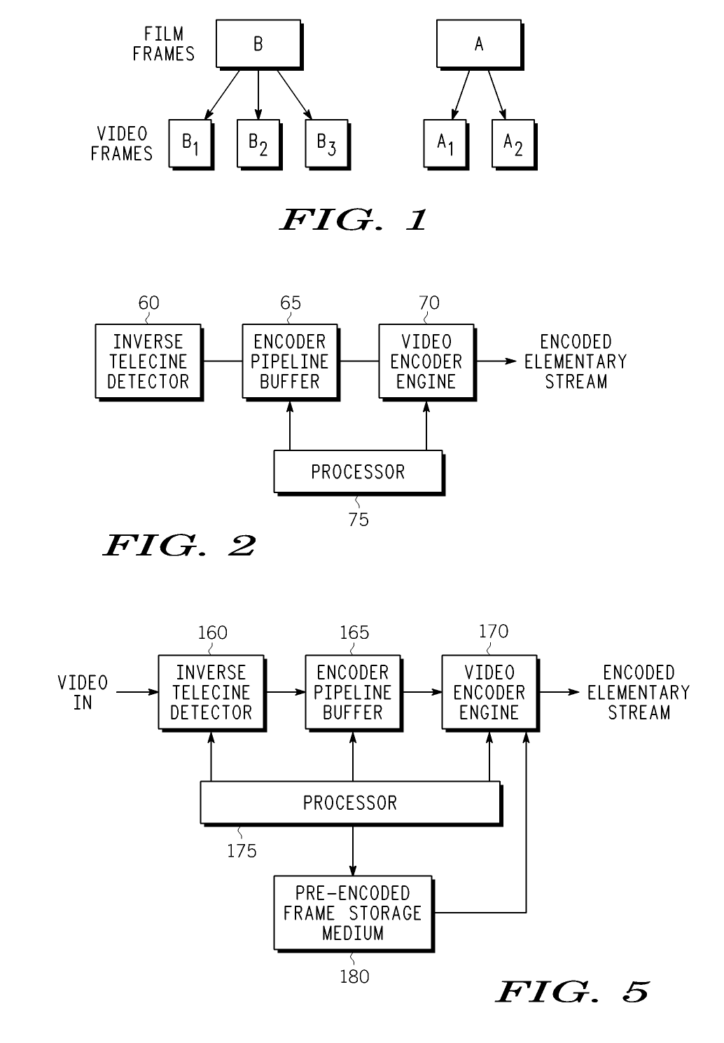

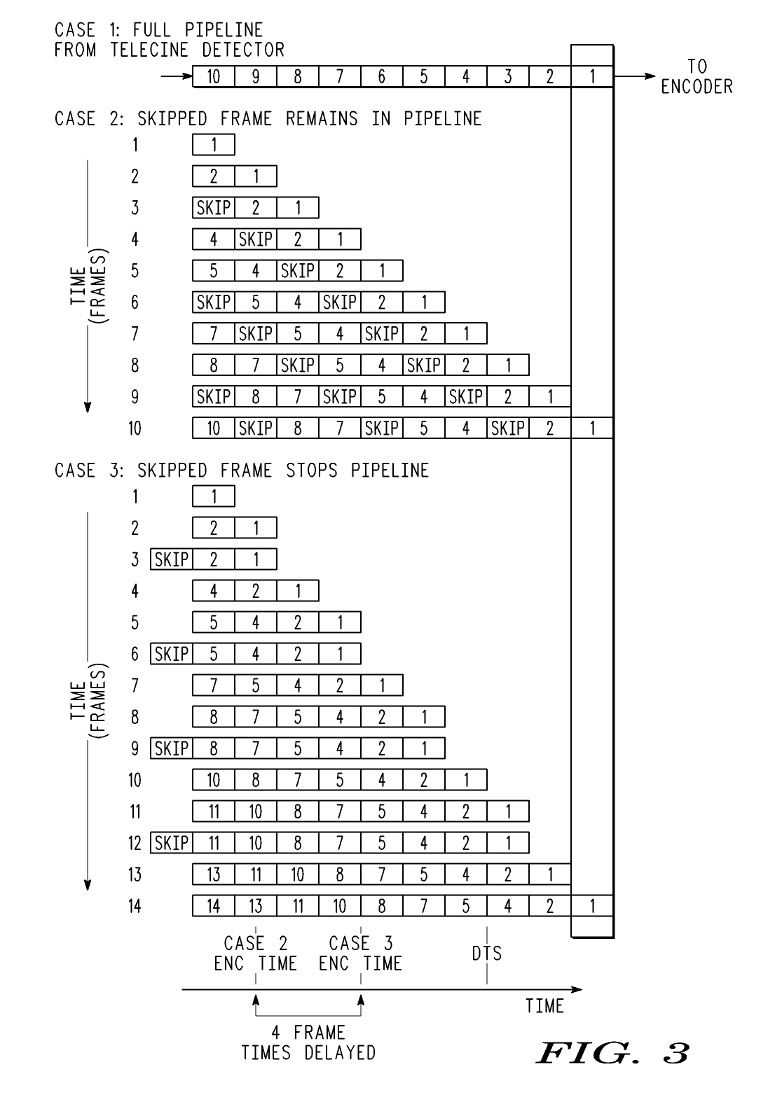

Since in the example of FIG. 7 m=3, there are two B frames between P frames. Assuming the video has been processed using a 3:2 pull down process, the frame sequence is 3 identical frames followed by two identical frames (see FIG. 1). As is evident from FIG. 7, for the set of 3 identical frames, in this example one of them will always be a P frame and the other two will be B frames. The possible sequences of these 3 identical frames may be BBP, BPB, or PBB. Regardless of the sequence, the P frame will be encoded. Instead of dropping the B frames, however, they are each replaced with a pre-encoded, stored frame. In the case of a dropped B frame, the pre-encoded frame is a pre-encoded B frame that uses the P frame as its reference frame. Since the B and P frames are identical, the motion vectors of the pre-encoded B frame will be zero and the Discrete Cosine Transform (DCT) residual coefficients will be zero. In this way the pre-encoded B frame effectively informs the decoder that it is identical to the previous or subsequent P frame. Since a B frame may reference either a previous or subsequent P frame, two pre-encoded B frames are stored, one to reference a previous P frame and one to reference a subsequent P frame.

Among other advantages of this technique, since the motion vectors and residual coefficients of the pre-encoded B frame are zero, the pre-encoded B frame will be very small in size. In addition, because it has been pre-encoded, the resources of the encoder will be conserved.

As explained above, when the set of three identical frames in the frame sequence shown in FIG. 7 are to be encoded, the P frame is encoded and the B frames are replaced with pre-encoded B frames that reference the P frame. For the set of two identical frames, there are three possible sequences that may arise: PB, BP and BB. In the first two cases, one of the frames is a P frame. In each of these cases the P frame will be encoded and the B frame will be replaced with a pre-encoded B frame in the manner described above. On the other hand, in the third case, both identical frames are B frames. Since there is no identical anchor frame for these B frames to reference, neither of them can be replaced with a pre-encoded frame. Instead, this situation may be handled in one of two ways.

In particular, when the set of two identical frames are B frames, both B frames may be encoded. On the other hand, one of the B frames may be encoded and the other B frame may be dropped in the conventional manner. While this latter option will cause a pipeline delay, the delay will be much less that the delay that occurs when all repeated frames are dropped. For instance, if one in ten frames is dropped, a 100 ms delay will occur in a pipeline that has a duration of one second. In contrast, as previously mentioned, a delay of 600 ms will arise in the case of 3:2 pulldown when three of every five frames are dropped. Of course, as previously mentioned, the methods and techniques described above not limited to video that has been processed using a 3:2 pulldown process, but is equally applicable to video that has been processed using other telecine processes as well. In another method, one of the B frames may be replaced by a P frame, thus dynamically changing “m”. The remaining B frame of the pair will then be coded with a pre-encoded frame.

Although not illustrated in FIG. 7, when a set of identical frames includes a P frame and an I frame, the I frame will be encoded and the P frame will be replaced with a pre-encoded P frame having motion vectors with values of zero and residual coefficients of zero. When a set of identical frames includes two P frames, the first P frame will be encoded and the second P frame will be replaced with a pre-encoded P frame having motion vectors with values of zero and residual coefficients of zero. Accordingly, the pre-encoded frame storage 180 will store a first pre-encoded B frame referencing a previous P frame, a second pre-encoded B frame referencing a subsequent P frame, and a pre-encoded P frame referencing an I or P frame, wherein the first and second pre-encoded B frames and the pre-encoded P frame each have motion vectors with values of zero and residual coefficients of zero.

The processes described above may be implemented in a video encoder such as the illustrative video encoder shown in FIG. 5. In operation, the inverse telecine detector 160 receives the video frames that are to be encoded and generates a telecine detection signal identifying repeated frames. The telecine detection signal may be, for example, a tag or flag that is placed in an appropriate data structure associated with the repeated frame, such as an MPEG system table, for example. The encoder pipeline buffer 165 stores the video frames, both tagged and untagged. The pre-encoded frame storage medium 180 stores the pre-encoded P and B frames. The video frames are sequentially delivered from the encoder pipeline buffer 165 to the encoder engine 170 under the control of the processor 175. The processor 175 also identifies the frames that have been tagged as repeat frames and causes them to be replaced with the appropriate pre-encoded frames accessed from the pre-encoded frame storage medium 180 before delivering them to the encoder engine 170, which encodes the frames that have yet been encoded to produce an encoded elementary video stream at its output.

The processes described above, including but not limited to those performed by the video encoder shown in FIG. 5, may be implemented in a general, multi-purpose or single purpose processor. Such a processor will execute instructions, either at the assembly, compiled or machine-level, to perform that process. Those instructions can be written by one of ordinary skill in the art following the description herein and stored or transmitted on a computer readable medium. The instructions may also be created using source code or any other known computer-aided design tool. A computer readable medium may be any physical medium capable of carrying those instructions and include a CD-ROM, DVD, magnetic or other optical disc, tape, and silicon memory (e.g., removable, non-removable, volatile or non-volatile).

Although various embodiments are specifically illustrated and described herein, it will be appreciated that modifications and variations of the present invention are covered by the above teachings and are within the purview of the appended claims without departing from the spirit and intended scope of the invention.

1. A video encoder, comprising:
an inverse telecine detector for receiving video frames and generating a telecine detection signal identifying repeated frames;
an encoder pipeline buffer for storing unrepeated video frames received from the inverse telecine detector;
an encoder engine for encoding the unrepeated video frames received from the encoder pipeline buffer;
a pre-encoded frame storage medium for storing pre-encoded frames; and
a processor configured to cause the encoder engine to replace selected frames that have been identified as repeating frames by the inverse telecine detector with a pre-encoded frame accessed from the pre-encoded frame storage medium.

2. The video encoder of claim 1 wherein the processor is further configured to stop progression of the pipeline to the encoder engine if a repeated frame is dropped instead of being replaced.

3. The video encoder of claim 2 wherein the video frames received by the inverse telecine detector includes at least one sequence of frames with two or more identical frames and the inverse telecine detector removes any repeating frames so that a single frame remains in each sequence, wherein the single frame is a P frame and the repeating frames include at least one B frame and the pre-encoded frame storage medium stores a pre-encoded B frame having motion vectors with values of zero and residual coefficients of zero and wherein the processor causes the encoder to replace the at least one B frame with the pre-encoded B frame stored in the pre-encoded frame storage medium.

4. The video encoder of claim 2 wherein the video frames received by the inverse telecine detector include at least one sequence of frames with two or more identical frames and the inverse telecine detector removes any repeating frames so that a single frame remains in each sequence, wherein the single frame is an I frame and the repeating frames include at least one P frame and the pre-encoded frame storage medium stores a pre-encoded P frame having motion vectors with values of zero and residual coefficients of zero and wherein the processor causes the encoder to replace the at least one P frame with the pre-encoded P frame stored in the pre-encoded frame storage medium.

5. The video encoder of claim 3 wherein the video frames received by the inverse telecine detector include a second sequence of frames with two or more identical frames and the inverse telecine detector removes any repeating frames in the second sequence so that a single frame remains therein, wherein the single remaining frame is a first B frame and the repeating frames are all B frames and the processor causes all the repeating B frames in the second sequence to be dropped.

6. A method of encoding a series of video frames, comprising:
receiving a series of video frames;
detecting a pattern in the series indicative of a telecine process;
removing repeated video frames from the series of video frames; and
replacing the repeated video frames that have been removed with pre-encoded video frames selected from a plurality of pre-encoded video frames; and
sequentially encoding each of the video frames in the series of frames that have not been pre-encoded.

7. The method of claim 6 wherein one of the repeated frames that is replaced is a B frame that references a P frame identical to the B frame, the pre-encoded frame with which the B frame is replaced is a pre-encoded B frame having motion vectors with values of zero and residual coefficients of zero.

8. The method of claim 7 wherein the P frame that the B frame references is a previous or subsequent P frame.

9. The method of claim 6 wherein the telecine process is a 3:2 telecine process.

10. The method of claim 6 wherein the plurality of pre-encoded video frames that are stored include a first pre-encoded B frame referencing a previous P frame, a second pre-encoded B frame referencing a subsequent P frame, and a pre-encoded P frame referencing an I frame, wherein the first and second pre-encoded B frames and the pre-encoded P frame each have motion vectors with values of zero and residual coefficients of zero.

11. The method of claim 6 wherein the single remaining frame in the sequence is a B frame and the repeated frames that are removed include one or more B frames, and further comprising replacing and encoding the remaining B frame with a P frame and replacing the remaining B frame with a P frame and replacing the repeating B frame with a pre-encoded B frame having motion vectors with values of zero and residual coefficients of zero.

12. At least one computer-readable medium encoded with instructions which, when executed by a processor, performs a method including:
receiving a series of video frames that includes at least one sequence with two or more identical frames;
removing repeated frames from the sequence so that a single frame remains therein;
encoding the single frame in the sequence; and
replacing the repeated frames that have been removed from the sequence with pre-encoded frames.

13. The computer-readable medium of claim 12 wherein the single remaining frame in the sequence is a P frame and the repeated frames that are removed include at least one B frame, and further comprising encoding the P frame and replacing the at least one B frame with a pre-encoded B frame having motion vectors with values of zero and residual coefficients of zero.

14. The computer-readable medium of claim 13 wherein the P frame that the B frame references is a previous or subsequent P frame.

15. The computer-readable medium of claim 12 wherein the series of video frames are processed in accordance with a telecine process.

16. The computer-readable medium of claim 15 wherein the telecine process is a 3:2 telecine process.

17. The computer-readable medium of claim 12 wherein the series of video frames includes a second sequence with two or more identical frames and the single remaining frame in the second sequence is a first B frame and the repeated frames that are removed are all B frames, and further comprising encoding the repeated frames in the second sequence.

18. The computer-readable medium of claim 12 wherein the series of video frames includes a second sequence with two or more identical frames and the single remaining frame in the second sequence is a first B frame and the repeated frames that are removed are all B frames, and further comprising dropping the repeated B frames from the second sequence.

19. The computer-readable medium of claim 12 wherein the single remaining frame in the sequence is an I frame and the repeated frames that are removed include at least one P frame, and further comprising encoding the I frame and replacing the P frame with a pre-encoded P frame having motion vectors with values of zero and residual coefficients of zero

20. The computer-readable medium of claim 12 wherein the single remaining frame in the sequence is a B frame and the repeated frames that are removed include one or more B frames, and further comprising replacing and encoding the remaining B frame with a P frame and replacing the remaining B frame with a P frame and replacing the repeating B frame with a pre-encoded B frame having motion vectors with values of zero and residual coefficients of zero.
